(19) United States
(12) Patent Application Publication
(10) Pub. No.: US 2018/0008045 A1
(43) Pub. Date: Jan. 11, 2018

(54) BACKBOARD FASTENER

(71) Applicant: Kai-Wei LIN, Huaian (CN)

(72) Inventor: Chen-Chiu CHU, Huaian (CN)

(21) Appl. No.: 15/344,708

(22) Filed: Nov. 7, 2016

(30) Foreign Application Priority Data
Jul. 7, 2016 (CN) 201620716448.8

(51) Int. Cl. A47B 97/00; F16B 41/00; F16B 21/16

(52) U.S. Cl. CPC A47B 97/001; F16B 21/16; F16B 41/002

(57) ABSTRACT

The present patent discloses a backboard fastener, comprising a male buckle and a female buckle; the male buckle and the female buckle are fitted to each other; a plurality of barbs are provided at one end of the male buckle, while a pressing face is provided at the other end thereof; and, a plurality of externally circular barbs are provided on the female buckle, an enlarged opening is provided at one end of the female buckle, and bumps corresponding to the barbs are provided inside the female buckle. The present patent has a simple structure, solves the problem of nail or screw rusting, does not need any mounting tool, and has a plurality of barbs so that falling-off is prevented. The present patent is suitable for components of various thicknesses and various occasions.

### FIELD OF THE INVENTION

The present patent relates to a fastener and in particular to a backboard fastener.

### BACKGROUND OF THE INVENTION

In the conventional techniques, when a backboard (for example, a fixing backboard for furniture such as a cabinet) is jointed to a frame, the backboard is usually nailed to the wood frame by nails or screws. This fixation way is inconvenient for operation, and the jointing can be realized by using a screw driver or a hammer. Moreover, as a major problem, the component appearance will be damaged since the snails or screws will be rusted, so that the overall appearance does not look beautiful. Or even, the screws cannot be disassembled.

Fixed fasteners are also used for jointing in the past. However, there are some problems in use. When a fastener with barbs is used, components cannot be disassembled after being assembled. If the components are required to be detachable, the components would become loose when they are impacted (for example, kicked), so that it is inconvenient for use.

### SUMMARY OF THE INVENTION

An objective of the present patent is to provide a backboard fastener in order to solve the problems mentioned in the background art.

For this purpose, the present patent employs the following technical solutions.

A backboard fastener is provided, including a male buckle and a female buckle; the male buckle and the female buckle are fitted to each other; a plurality of barbs are provided at one end of the male buckle, while a pressing face is provided at the other end thereof; and, a plurality of externally circular barbs are provided on the female buckle, an enlarged opening is provided at one end of the female buckle, and bumps corresponding to the barbs are provided inside the female buckle.

As a further solution of the present patent, the pressing face of the male buckle is arc.

Compared with the prior art, the present patent has a simple structure, solves the problem of nail or screw rusting, does not need any mounting tool, and has a plurality of barbs so that falling-off is prevented. The present patent is suitable for components of various thicknesses and various occasions.

### BRIEF DESCRIPTION OF THE DRAWINGS

FIG. 1 is a structural diagram of a male buckle in Embodiment 1 of a backboard fastener;

FIG. 2 is a structural diagram of a female buckle in the backboard fastener;

FIG. 3 is a diagram showing steps of assembling the backboard fastener; and

FIG. 4 is a schematic diagram of the backboard fastener when it has been assembled.

### DETAILED DESCRIPTION OF THE PREFERRED EMBODIMENTS

The technical solutions in the embodiments of the present patent will be clearly and completely described below with reference to the accompanying drawings in the embodiments of the present patent. Apparently, the embodiments described herein are merely a part but not all of the embodiments of the present patent. All other embodiments obtained by a person of ordinary skill in the art on the basis of the embodiments in the present patent without paying any creative effort shall fall into the protection scope of the present patent.

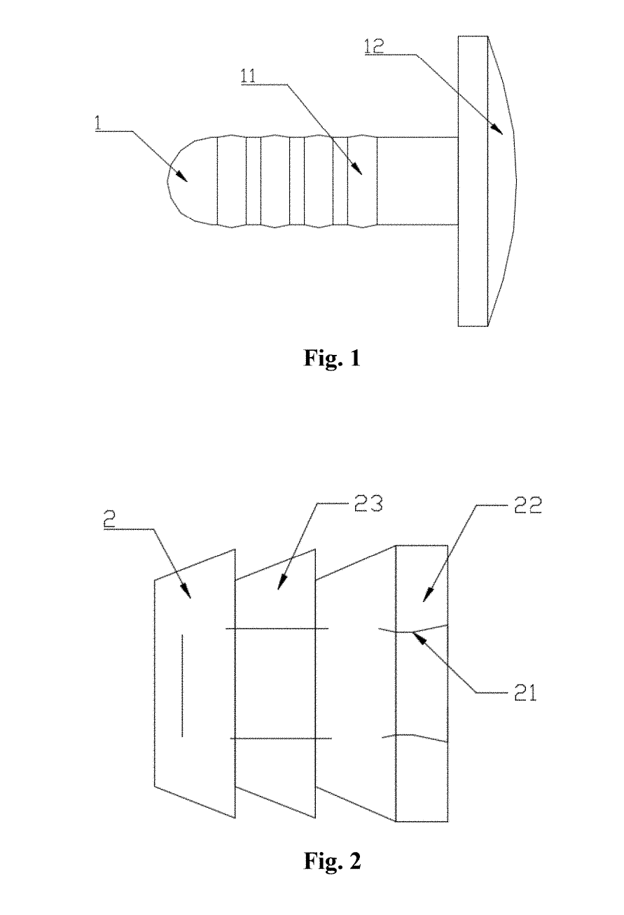

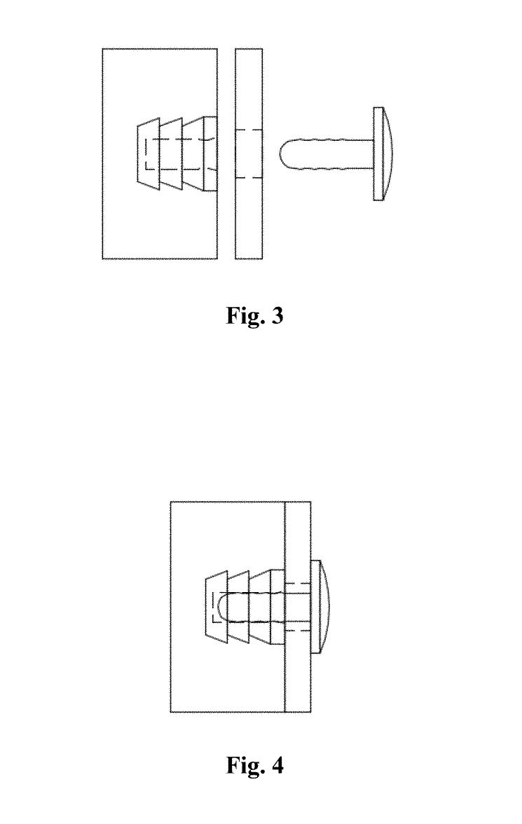

With reference to FIGS. 1-4, in an embodiment of the present patent, a backboard fastener is provided, including a male buckle 1 and a female buckle 2. The male buckle 1 and the female buckle 2 are fitted to each other. A plurality of barbs 11 are provided at one end of the male buckle 1, while a pressing face 12 is provided at the other end thereof. When a backboard needs to be assembled, the barbs 11 are pressed into the backboard by directly pressing the pressing face 12 by hands. A plurality of externally circular barbs 23 are provided on the female buckle 2. After the female buckle 2 is fixed on a component, the externally circular barbs 23 prevent from falling-off. An enlarged opening 22 is provided at one end of the female buckle 2, and the enlarged opening 22 is convenient for the insertion of the male buckle 1. Bumps 21 corresponding to the barbs 11 are provided inside the female buckle 2 for purpose of preventing falling-off. The pressing face 12 of the male buckle 1 is arc.

A method for assembling the backboard fastener provided by the present patent includes the following steps of:

a. preassembling the female buckle 2 on one component to be assembled; and

b. inserting the male buckle 1 into the female buckle 2 after passing through the component to be assembled.

The present patent has a simple structure, solves the problem of nail or screw rusting, does not need any mounting tool, and has a plurality of barbs so that falling-off is prevented. The present patent is suitable for components of various thicknesses and various occasions.

It is apparent for those skilled in the art that the present patent is not limited to the details of the exemplary embodiment, and the present patent can be implemented in other specific forms without departing from the spirit or essential features of the present patent. Therefore, from every point of view, the embodiment should be exemplary but not limiting, and the scope of the present patent shall be defined by the appended claims but not by the foregoing description. Hence, all variations made within the meaning and scope of equivalences of the claims shall be included in the present patent. The reference numerals in the claims shall not be regarded as limiting the involved claims.

In addition, it should be understood that, although the present specification has been described by implementations, not every implementation merely includes one independent technical solution. The narration mode of the specification is merely for clarity, and those skilled in the art shall regard the specification as a whole. The technical solutions in various embodiments may also be properly combined to form other implementations that can be understood by those skilled in the art.

What is claimed is:

1. A backboard fastener, comprising a male buckle (1) and a female buckle (2); the male buckle (1) and the female buckle (2) are fitted to each other; a plurality of barbs (11) are provided at one end of the male buckle (1), while a pressing face (12) is provided at the other end thereof; and, a plurality of externally circular barbs (23) are provided on the female buckle (2), an enlarged opening (22) is provided at one end of the female buckle (2), and bumps (21) corresponding to the barbs (11) are provided inside the female buckle (2).

2. The backboard fastener according to claim 1, wherein the pressing face (12) of the male buckle (1) is arc.
